(19) United States
(12) Patent Application Publication
(10) Pub. No.: US 2009/0307299 A1
(43) Pub. Date: Dec. 10, 2009

(54) System Analysis Modeling Apparatus and Method

(76) Inventors: Michael Malesich, Cherry Hill, NJ (US); Steven Roman, Rockledge, FL (US); Jacques Severe, Aberdeen, NJ (US); John Stanberry, Jackson, NJ (US); Gar Cheng, Edison, NJ (US); Andrew Joskowski, Colts Neck, NJ (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(21) Appl. No.: 12/136,427

(22) Filed: Jun. 10, 2008

(51) Int. Cl. G06F 15/16

(52) U.S. Cl. 709/202

(57) ABSTRACT

A modeling and simulation apparatus and method for simulating a complex system includes linking together a plurality of computerized models. The models include at least one process model and one or more of a product model, information model and computer console emulator model. Communication clients for each model are connected to a communication server. The method includes transmitting a message from a communication client of a model to the communication server, the message including a class of information and a unique identifier corresponding to the class of information being transmitted; sorting messages received at the communication server into groups according to unique identifiers; queuing the messages within each group temporally; storing the grouped and queued messages at the communication server; and retrieving the transmitted message from the communication server using a second communication client of a second model.

### STATEMENT OF GOVERNMENT INTEREST

The inventions described herein may be manufactured, used and licensed by or for the U.S. Government for U.S. Government purposes.

### REFERENCE TO COMPUTER PROGRAM LISTING APPENDIX

A computer program listing is hereby expressly incorporated by reference. The appendix includes two duplicate compact discs. The files on each compact disc, their size in bytes, and the date created are as follows:

| File Name | Size | | Date Created |
|---|---|---|---|
| GLOBALS | 1 | KB | Apr. 27, 2007 |
| RLCIDLL | 9 | KB | Apr. 27, 2007 |
| RLCIDLL | 2 | KB | Apr. 27, 2007 |
| RLCITEST | 2 | KB | Apr. 27, 2007 |
| CLIENT | 4 | KB | Apr. 27, 2007 |
| TEST | 4 | KB | Apr. 27, 2007 |
| RLXLSERVER | 4 | KB | Apr. 27, 2007 |
| VISUAL BASIC FOR APPL | 6 | KB | Apr. 27, 2007 |
| RLCLIENT | 11 | KB | Apr. 27, 2007 |
| RLMA | 17 | KB | Apr. 27, 2007 |
| TOU | 1 | KB | Apr. 27, 2007 |
| RLJCLIENT | 3 | KB | Apr. 27, 2007 |
| SHOTLOG | 2 | KB | Apr. 27, 2007 |
| NAVSPLASH | 2 | KB | Apr. 27, 2007 |
| RLBEACON | 3 | KB | Apr. 27, 2007 |
| RLCLIENT | 11 | KB | Apr. 27, 2007 |
| RLFINAL | 1 | KB | Apr. 27, 2007 |
| RLICLIENT | 1 | KB | Apr. 27, 2007 |
| RLSCORE | 1 | KB | Apr. 27, 2007 |
| RLSERVER | 15 | KB | Apr. 27, 2007 |
| RLSPLASH | 2 | KB | Apr. 27, 2007 |
| DATA | 1 | KB | Apr. 27, 2007 |
| STUB | 1 | KB | Apr. 27, 2007 |
| RLMA | 7 | KB | Apr. 27, 2007 |
| RLMON | 4 | KB | Apr. 27, 2007 |
| RLSS | 7 | KB | Apr. 27, 2007 |

### BACKGROUND OF THE INVENTION

The invention relates in general to the design and analysis of complex systems and in particular to the use of Modeling and Simulation as a tool in such design and analysis.

There are many establishments, both military and civilian, which require various types of operations and system analysis to improve overall efficiency and/or productivity. The U.S. Navy is involved in and committed to a wide range of initiatives and programs focused on improving capability and reducing Total Costs of Operations (TOC) for fleet assets. By way of example, in the field of Navy aircraft carriers, operations on board a carrier include simultaneous functions such as aircraft launch and recovery, flight deck operations, fueling, aircraft weapons handling and loading, etc. Process and information handling of these typical operations must be effective, efficient and cost effective. There are many proposed solutions for particular aspects of Naval operations, each with its own feasibility, risk, and cost factors. Evaluating the proposed solutions is difficult. There is a need for a method to evaluate different proposed solutions that is not biased, allows for complete evaluation, and considers impacts to associated processes and systems.

Modeling and Simulation (M&S) has been used to support operations analysis and system design for many years. However, the use of specific M&S tools has been constrained to particular domains. For example, product (e.g. Computer Aided Design (CAD) or visualization) models have been limited to the mechanical and electrical engineering domains, along with the manufacturing domains. At the same time, process models (e.g. Business Process Reengineering (BPR)) tools have been limited to the operations, or industrial engineering domain. This has led to M&S analyses being limited in their applicability, and providing results that might be sub-optimal, since other aspects and impacts are not considered. This is one of the major criticisms of M&S for defense and industry applications.

Another criticism of M&S has been the amount of funding and time required to develop the models before any practical use may be made of them. In a world of reduced budgets and timeframes, there is little room for expensive, extended development efforts that do not directly result in final products. M&S has always aided in this environment by allowing for virtual prototypes to be analyzed before production takes place, thus saving time and money in terms of reduced “false starts”. However, as M&S is applied to very complex environments, such as an aircraft carrier (CV), the amount of time and funding required to develop the model itself often becomes a drain to precious program resources.

### SUMMARY OF THE INVENTION

It is an object of the invention to provide a method for evaluating and analyzing complex systems through computer simulation and modeling.

It is another object of the invention to provide a method of simulating a system by linking together a plurality of models.

It is a further object of the invention to provide a method of communication between disparate computer models.

Still another object of the invention is to provide a method for linking together process models, product models, information models and computer console emulators.

One aspect of the invention is a method of communication between computerized models comprising providing a communication server; providing a communication client for each of the models, the communication server being connected to each of the communication clients; sorting information to be exchanged between the models into classes; assigning a unique identifier for each class of information; transmitting a message from a communication client to the communication server, the message including a class of information and the unique identifier corresponding to the class of information being transmitted; sorting messages received at the communication server into groups according to the unique identifier; queuing the messages within each group temporally; storing the grouped and queued messages at the communication server; for each model, identifying which classes of information are needed to operate the model and providing the unique identifiers of the needed classes to the model's communication client; and using a model's communication client, retrieving a message from the communication server that contains at least one of the unique identifiers provided to the model's communication client.

The method may further comprise, for a class of information to be received by more than one model, assigning a number of unique identifiers equal to a number of receiving models.

The method may further comprise assigning two unique identifiers to a class of information that, when transmitted, requires a reply message.

In a preferred embodiment, the step of transmitting the information in a message from the communication client to the communication server includes transmitting the information in a message of a string data type.

The step of using a model's communication client to retrieve a message from the communication server may include pausing further operation of the model until the message is retrieved. Or, the step of using a model's communication client to retrieve a message from the communication server may include continuing operation of the model whether or not the message is retrieved. Also, the step of transmitting a message from a communication client to the communication server may include continuing operation of the model after the message is transmitted to the communication server.

The method may further comprise providing an object server having a communication client connected to the communication server; assigning a unique identifier for each object; and including the unique identifier in messages transmitted from the models' communication clients to the object server.

In one embodiment, the method includes creating a log of all messages transmitted to the communication server and storing the transmitted messages. Additionally, for each communication client, the method may include creating a file of all messages transmitted to the communication server by that communication client.

Another aspect of the invention is a method of communication between computerized models comprising providing a communication server; providing communication clients for each of the computerized models, the communication server being selectively connected to one or more of the communication clients; transmitting a message from a communication client of a model to the communication server, the message including a class of information and a unique identifier corresponding to the class of information being transmitted; sorting messages received at the communication server into groups according to unique identifiers; queuing the messages within each group temporally; storing the grouped and queued messages at the communication server; and retrieving the transmitted message from the communication server using a second communication client of a second model.

Yet another aspect of the invention is an apparatus comprising at least one computer including at least one process model linked to one or more of a product model, information model and computer console emulator model; respective communication clients for each model; a communication server selectively connectable to the respective communication clients; means for transmitting a message from a communication client of a model to the communication server, the message including a class of information and a unique identifier corresponding to the class of information being transmitted; means for sorting messages received at the communication server into groups according to unique identifiers; means for queuing the messages within each group temporally; means for storing the grouped and queued messages at the communication server; and means for retrieving the transmitted message from the communication server using a second communication client of a second model.

A further aspect of the invention is a computer readable medium containing a computer program for performing all or part of the method of the invention.

The invention will be better understood, and further objects, features, and advantages thereof will become more apparent from the following description of the preferred embodiments, taken in conjunction with the accompanying drawings.

### BRIEF DESCRIPTION OF THE DRAWINGS

In the drawings, which are not necessarily to scale, like or corresponding parts are denoted by like or corresponding reference numerals.

FIG. 1 is a block diagram of one embodiment of an apparatus in accordance with the invention.

FIG. 2 is a diagram of one embodiment of the software architecture of the communication server.

FIG. 3 is a block diagram of the physical architecture of one embodiment of the invention.

### DETAILED DESCRIPTION OF THE PREFERRED EMBODIMENTS

The U.S. Navy's Advanced Launch and Recovery Control System (ALRCS) program is an example of the type of system that can benefit from the present invention. ALRCS provides catapult and arresting gear control systems that improve the performance, reliability, and safety of systems aboard existing and future aircraft carriers. Due to the complexity of aircraft launch and recovery operations aboard aircraft carriers, it is apparent that Modeling and Simulation (M&S) should be utilized to help define the requirements and design of ALRCS. The inventive method may be used to help identify opportunities for automation and process re-engineering, define requirements of the ALRCS system, and evaluate alternatives through simultaneous analysis of impacts on processes, personnel, and operational performance. The ability to perform simultaneous analyses ensures a more efficient “total ship” solution.

Some of the advantages of the invention include: assistance in identifying opportunities for improvement of ship systems and operations in addition to evaluating concepts for improvement; providing for analysis of system design, development, and utilization; providing support for the implementation and testing of systems; allowing for high-level analysis in the short term, with the ability for successive refinement for more detailed analyses; supporting “Total Environment” versus “Stovepipe” analyses; and allowing for models to be integrated so that a virtual aircraft carrier (or other entity for commercial applications) may be built in piecewise fashion.

In the realm of aircraft carrier processes and systems, the virtual environment includes operator console mock-ups, man-in-the-loop capability, and extensive flexibility of the communications bridge (multiple operating systems, multiple models handled, self configuring for network entities, link to databases and spreadsheets, link to other COTS tools (e.g. systems engineering tools)). These features ensure the usefulness and applicability of the virtual environment to a wide range of defense and commercial situations. The virtual environment allows for multi-level analysis of proposed enhancements thereby allowing system engineers, hardware and software developers, and customers (or end users) to gain insight into the requirements, design, and benefits of a system being designed and developed.

The invention is based on the integration of COTS (Commercial Off The Shelf) tools for process modeling, product modeling, information modeling, and computer console emulation. The inventive method provides for communication between these COTS tools. Furthermore, the communications are synchronized so that analyses may be performed across these modeling domains simultaneously. An analysis needs to consider the three domains of process modeling, product modeling and information modeling, as well as human impacts and interfaces, simultaneously.

### Process Models

Process models are used to graphically describe the activities that must occur for some operation to take place. The activities may be described at the required level of detail to perform a specific analysis. For example, if one wishes to analyze different aspects of automobile manufacturing, the individual may describe very high-level activities (e.g. body assembly, painting, quality assurance), without the details of how each activity is carried out. Conversely, the individual may want to describe the activity of installing the engine to a much greater level of detail (e.g. the types and quantities of fasteners used, the specific job of each person involved, the model number of equipment and tools required). In any event, the process model must describe the relationships between the activities that make up an operation (how the outputs of one activity are used as inputs of other activities), the people and equipment used, and the controls that must be followed (e.g. supervisor commands, standard procedures). Process models are used to improve efficiency, study personnel and equipment utilization, and identify opportunities for automation in an operation.

### Product Models

There are two general categories of product models: those that model the physics of equipment or components (e.g. an engine simulation); and those that model the physical environment (e.g. a visualization of a hospital emergency room). Physics-based models rely on mathematical formulas and probability theory to provide predictions and estimates of various aspects of system performance (e.g. failure rate, heat production, ability to handle desired throughput). Visualization models provide 2-dimensional, or more commonly, 3-dimensional views of equipment or work areas for the purpose of understanding how equipment and humans will interact in reality. Ergonomic issues and maximum capacity are often the subject of analyses requiring visualization models.

### Information Models

Information models are used to describe how data is created and communicated among people and computer systems. The relationships between data entities (e.g. who uses the data, whether the data is a piece of a larger data element) is also an important aspect of information models. Information models are often used when a new computer system (e.g. a database) is to be introduced to an existing operation. In fact, some information models are closely aligned to database models (called schemas). In such cases, information models describe the current flow of data in the operations to ensure that no data is lost when the new computer system is introduced. Information models are also used to merge the data when a new computer system is to be added to an existing computer system. Information models can also be used in human-only situations, such as when personnel are to be reduced in an operation, but the data that was processed by those leaving the operation must still be maintained.

### Console Emulation

Computer console emulation is used to ensure that humans will be comfortable with a new computer display before the new display is developed. In this way, development costs are reduced since the human has a chance to evaluate the emulation, and can make suggestions for improvement before extensive development has been completed. Computer console emulation is also used for training, so that humans can practice on realistic systems, before using the actual systems in operations.

### Building a Simulation for a Complex System

Process models, product visualizations, information models, and console emulators have been used for many years. As is known in the art, when one desires to create a computer simulation of a known process or product, one may purchase a COTS process or product computer software model and then customize or adapt the model to conform to the particular process or product being modeled. For complex systems, however, it is not possible to find a single process or product model that can adequately simulate the complete system. As discussed above, a complex system may require multiple process, product, information and computer console models simultaneously. The problem is how to link the multiple, disparate models together in a single, simultaneous simulation.

The solution includes customizing the various models, as is known, and, additionally, programming the models to transfer information between themselves. In this way, the multiple models become linked and more accurately simulate the actual system. In the invention, the interaction between the models is the transmission and receipt of messages containing information. Thus, in addition to the usual customizing procedure, each model is additionally programmed to transmit and/or receive messages containing specific classes of information. The process of programming each model to transmit and/or receive messages is typically an iterative one. The sending model(s), the receiving model(s) and the class of information contained in each message must be determined and each model must be programmed accordingly. However, the inventive method does not require that models that transmit messages “know” the particular recipient model(s) or that models that receive messages “know” the particular sender model(s). From a model's viewpoint, the model-to-model communication is essentially anonymous.

A unique feature of the invention is the integration of the disparate modeling domains so that they may be used simultaneously to perform analyses across the domains. Not only are the models integrated, a mechanism for synchronization is provided so that the process models control the overall execution of the virtual environment. The models act in a shared virtual environment, whether they are on separate computers, or in different buildings, or in a training environment that spans several spaces involved in an operation.

A communications bridge links together the models of a simulation. The bridge works on sequential programming PULL technology that matches most COTS interfaces. In PULL technology applications, information is provided to receivers when they request it. In contrast, in PUSH technology, information is provided by senders without a request by receivers. By making the request for information, PULL technology provides the information to the application that needs it when it is needed. Message traffic is reduced, compared to PUSH technology, in that attempts to make the transmission are not made until the information is needed. PUSH technology in these types of environments if often not even possible, but in situations where it could be used, PUSH technology would require attempts for delivery from the time the information was available.

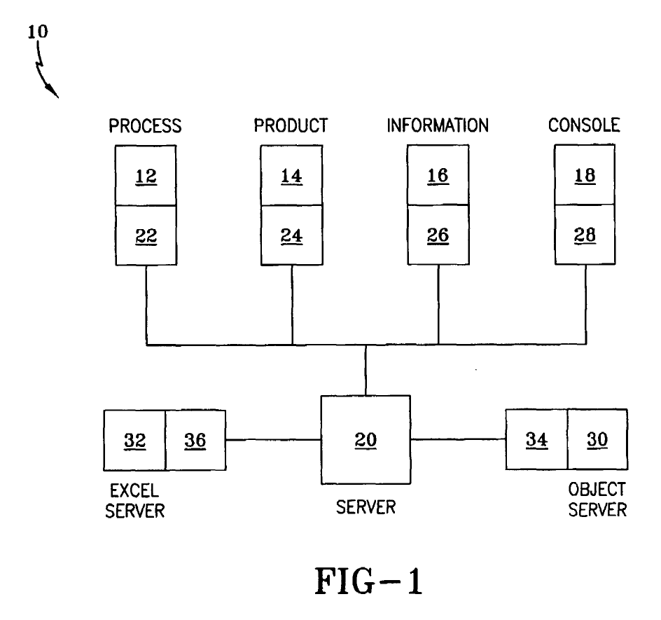

FIG. 1 is a schematic representation of one embodiment of an apparatus 10 for simulating a “real world” system. In any simulation, at least one process model 12 is used. Then, at least one process model 12 is linked to at least one of a product model 14, information model 16 and computer console model 18. Computer console models may be considered a subtype of product models. The process model 14 may be linked to multiple product models 14, information models 16 and computer console models 18 simultaneously. There may also be additional process models 12. The models 12, 14, 16 and 18 are typically software programs that are loaded and run on a computer. In a simple simulation, it is possible that the models are loaded into and run on a single computer. More commonly, however, each model resides on its own computer.

Each model 12-18 is provided with a respective communication client 22, 24, 26, 28 and is connected to a common communication server 20 through its respective communication client 22, 24, 26, 28. The communication clients 22-28 interact with their respective models 12-18 and with the communication server 20. The communication server 20 is responsible for all message traffic between clients 22-28 and other servers. As noted above, when designing a simulation, one must determine the information that will be exchanged between the various models. This determination includes identifying the model that creates the information and the model that receives the information. The information to be exchanged is sorted into classes. A class of information may be virtually anything, but is typically a rather specific piece of information.

The invention uses the concept of “channels” for communication between models. In the invention, a class of information is a “channel.” Each channel is assigned a unique identifier, such as a numeral. Messages transmitted from the model's clients 22-28 to the server 20 include the channel identifier. The server 20 sorts the received messages into groups according to channel and queues the messages within each channel temporally. The server 20 stores the grouped and queued messages. The model's clients 22-28 retrieve messages from the server 20 based on the channel identifier. The order of retrieving messages on a particular channel is first in, first out.

Prior to beginning the simulation, each model 12-18 is programmed to transmit messages to the server 20 containing information generated or created by that model and required by at least one other model in the simulation. Likewise, each model 12-18 is programmed to retrieve messages from the server 20 containing information required by that model during the simulation. When the simulation is run, each model's client 22-28 transmits messages to the server 20 wherein each message includes a channel identifier. The clients 22-28 retrieve messages from the server 20 that contain the channel identifiers provided to the clients 22-28. This method is satisfactory if only a single model requires the particular information on a channel. If more than one model requires the information on a channel, then that class of information is assigned a number of unique identifiers (channels) equal to the number of receiving models.

For example, suppose two models 14, 16 require a particular class of information that is created or generated by model 12. The class of information is, for example, the velocity of a particular ship measured at thirty second intervals. Assuming numerals are being used to identify the channels (classes of information), two different numerals, for example, 515 and 516, will be assigned to the class of information that is the velocity of the particular ship measured at 30 second intervals. Every thirty seconds model 12 will generate the velocity of the ship and the client 22 for model 12 will send two messages to the server 20. The messages will be identical except that one message will include the channel identifier 515 and one message will include the channel identifier 516.

One of the clients 24, 26 of the models 14, 16 has been programmed to retrieve messages on channel 515 and the other of the clients 24, 26 has been programmed to retrieve messages on channel 516. During the simulation, the one client will retrieve all channel 515 messages sent by client 22 (or any other client) and the other client will retrieve all channel 516 messages sent by client 22 (or any other client). In this way, multiple recipients may receive the same information, albeit on different channels. Although this example involved two recipients, any number of recipients is possible.

One should note that the reverse situation, where multiple models create the same class of information that is to be used by (transmitted to) a single recipient model, does not require the use of multiple identifiers for the same class of information. That is, if models 12 and 14 both create a class of information that is assigned to channel 99, for example, the recipient model's client will retrieve all messages on channel 99 regardless of the origin, and will, therefore, receive messages from both models 12 and 14. The recipient model, however, will not know, and does not need to know, which model sent which message.

In some cases, the class of information that is transmitted is of a type that requires a reply. The sender may want verification that the message was received or that some action was taken in response to the transmitted information. For “reply required” classes of information, two identifiers are assigned to the class of information. Thus, two channels are used. For example, identifier 233 may be used for the sending channel and identifier 234 may be used for the reply channel. Thus, suppose model 12 sends a message on channel 233 to server 20. The recipient model retrieves the message from channel 233 and is programmed to generate a reply on channel 234. When model 12 seeks to find the reply to the message it sent on channel 233, it retrieves a message from channel 234.

Using the concept of channels helps to simplify the addressing between clients. Alternatives such as internet addresses and ports are not easy to remember or use. Each client retrieves messages from only those channels that are relevant to that client's model. The communication server 20, however, stores the messages of all channels. As many as 65,000 channels are available to a client. This number can easily be increased to 4 billion. The channel abstraction works best if a few guidelines are followed. First, a block of receive channels (for example, three hundred channels numbered 200-500) can be assigned to a particular model so that from the identity of the channel one can deduce to which model a message is heading. Prior to running the computerized simulation, all the interactions (messages) between the various models are planned.

The protocol for messages is defined so that the COTS tools can understand the information passed between them. The message protocol is generic and flexible so that it can be used for many different applications, both governmental and commercial. The data types and communications commands are generic across all applications.

Data types that flow on the communications interface are of a “string” type or the equivalent for the language that is being used. This string may be as simple as a status message or as complex as a serialized data object. Strings are used because they are human readable, work well with message logging and work well with saving sessions to file. Strings do not have problems representing numeric or Boolean data as passing numeric data types do. Byte ordering (big and little endian) is a problem when exchanging integers across different platforms. Differing specifications (IEEE vs. non-IEEE) are a problem when exchanging floating point numbers.

The user interface comprises the following commands:

1) startBridge(String SimName)

This command causes a model's communication client 22-28 to connect with the communication server 20 that is running the simulation. “SimName” is the name of the simulation.

2) stopBridge(String SimName)

This command causes a model's communication client 22-28 to disconnect from the communication server 20 that is running the simulation. “SimName” is the name of the simulation.

3) String nbRX(ChannelType aChannel)

This command causes a model's communication client 22-28 to retrieve a message from a particular channel at the server 20. If the server 20 has no message on that particular channel, the communication client's model continues its simulation process. This type of receive command is a “non-blocking receive.”

4) String RX(ChannelType aChannel)

This command causes a model's communication client 22-28 to retrieve a message from a particular channel at the server 20. If the server 20 has no message on that particular channel, the communication client's model pauses its simulation process until a message is retrieved from that channel. This type of receive command is a “blocking receive.”

5) TX(ChannelType achannel, String aMessage)

This command causes a model's communication client 22-28 to transmit a message containing a particular channel identifier to the server 20. After the message is transmitted to the server 20, the transmitting model continues its simulation process.

These commands would normally be methods associated with the communications bridge Client Class in object-oriented languages. They would be function calls in non-object oriented languages. The communication server 20 may be implemented in both Java and C++, and the clients 22-28 may be implemented in C++, C (as a DLL), Visual Basic, Visual Basic for Applications, Java and Python. The communications server 20 has been tested on MS Windows NT/2000/XP, HP-UX v11.0, Redhat Linux v7.1, and Irix v6.5. In the future, other operating systems may be ported to. Clients 22-28 have been tested on MS Windows 98/ME/NT/2000/XP and Redhat Linux v7.1. The communication interface is a generic interface that may be easily ported to in almost any programming language or operating system.

Referring again to FIG. 1, the invention may also include an object server 30 that allows clients 22-28 to create and modify the attributes of objects at runtime. Object server 30 is connected to the communication server 20 via communication client 34. The object server 30 is required when communication is necessary between a model that organizes data by activity (rather than by the objects that flow through the activity) and a model that is object based. Object server 30 stores each object's attributes with the representation (name) of that object. Only the temporally last attributes are stored. Thus, the object server 30 does not use the concept of channels.

Each object is given a name. The clients 22-28 interact with the object server 30 using two types of commands. The first command is to put or set the state, value or attribute of the object. For example, the object may be a pressure reading in a pipeline that is updated every second. The object may he named PRESS, for example. The model (or models) that generate the pressure reading will send the pipeline pressure value to the object server 30 every second. The object server 30 will set the value or state of the object PRESS to the last received pressure reading. Thus, the object PRESS contains the last received value for the pipeline pressure.

The second command is to retrieve or get the state, value or attribute of the object and return it to a model. Thus, if one or more models need to know the pipeline pressure, the model or models will send a command to the object server 30 to retrieve the state or value of PRESS. A model may need to know PRESS only on an hourly basis, even though PRESS is updated every second. The model's communication client will send its retrieve command on an hourly basis and will retrieve the last posted value of PRESS. The past values of PRESS are not stored. Only the most recent value is maintained at the object server 30.

Typically, the models 12-18 are COTS. The models 12-18 may comprise a variety of computer languages and/or operating systems. Therefore, the interface between the models 12-18 and their respective client 22-28 may vary. Some COTS models can be loaded onto a computer containing the communication client software and interact successfully with the client software without any special programming. Other COTS models may require some special programming to successfully interact with their communications client. However, the programming required is generally only a few lines of code, for example, three or four lines of code.

The communications bridge was initially developed to meet the needs of the specific COTS tools and analysis needs of the ALRCS program. However, the open, flexible design ensures that the bridge may be used for a wide variety of applications, reduce the engineering effort to link any COTS model, and allow for reuse of the models and the communications bridge. The open nature of the bridge allows for incorporation of run-time data base management systems; allows for linking models across sites; is compatible with multiple languages (c, java, python, etc.), multiple interfaces (COM, DLL, etc.), and with applications across different platforms (UNIX, Windows, etc.).

The communications bridge provides linkage and synchronization of COTS tools for simultaneous analysis across systems domains. Further, the bridge allows COTS tools to have bi-directional control over the rate of information flow. This capability is an enhancement to traditional call-back methods where each application is controlled as to when to receive information.

Referring again to FIG. 1, the invention may also include an EXCEL server 32 connected to the communication server 20 via communication client 36. The EXCEL server 32 provides a common object model (COM) interface to MICROSOFT OFFICE applications on remote computers. The software architecture allows for any number of server types to be added as needed.

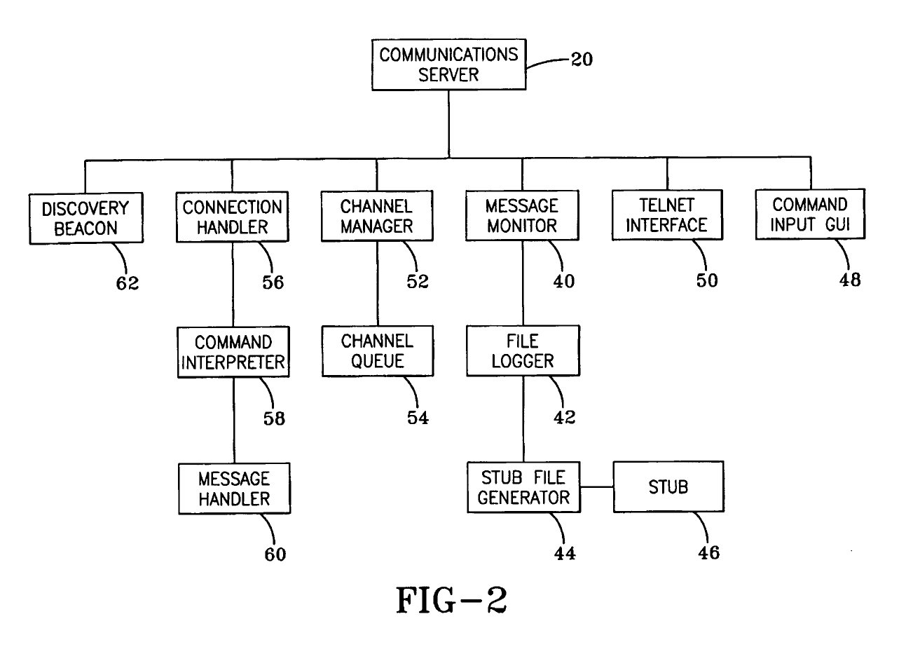

FIG. 2 is a diagram of one embodiment of the software architecture of the communication server 20. Included are a message monitor 40, a message logger 42, a semi-automated stub file generator 44, and a stub runner 46. All messages transmitted to the server 20 are logged, as well as error messages from any of the calls, and any debug messages that may be needed by the end user. These logged messages are time-stamped and stamped with the network address and machine name of the communication client that sent them.

The message monitor 40 is a graphical user interface (GUI) application that allows the user to view any of the logged messages for debugging or other purposes. When a large number of computers are interacting, it is sometimes difficult to judge where an error occurred. The message monitor 40 is a helpful tool for locating errors. The message logger 42 stores all the messages that the monitor 40 displays in a set of files. The semi-automated stub file generator 44 reads the files that the message logger 42 produces and generates a file of messages transmitted to the communication server 20 by each particular communication client. Thus, the semi-automated stub file generator 44 produces a history of the transmissions between each client and the server 20. Using this history, the simulation may be replayed to the server 20 at a later time by the stub utility.

For example, if one desires to investigate the performance of a particular model, the replay file would include the recorded messages from all clients except for the client of the particular model being investigated. That particular model would actually run its portion of the simulation again by interacting with the server 20, but the message traffic from all other clients would be the recorded message traffic from the stub files. The time data of the history can be used by the stub utility to even match the time gaps of the original messages sent. Replay may also be used to investigate more than one model. In that instance, the replay file would include the recorded messages from all clients except for the clients of the particular models being investigated. Those particular models would actually run their portion of the simulation again by interacting with the server 20, but the message traffic from all other clients would be the recorded message traffic from the stub files. The purpose of the replay function is to provide a means of demonstrating a portion of the simulation with only one or a few participating models, rather than every model that is a part of the overall simulation.

An alternative method of generating a replay file for a particular model or models is to create a file of the messages retrieved by each model during the simulation. The retrieved messages for a particular model are a subset of the messages transmitted by all the other models. For example, if one desires to investigate the performance of a particular model, the replay file would include the messages retrieved by that particular model during the actual simulation. As before, that particular model would actually run its portion of the simulation again by interacting with the server 20, but the message traffic from all other clients would be the recorded message traffic (that is, the messages retrieved by that model during the actual simulation) from the replay file.

Referring again to FIG. 2, other software components of the server 20 include a command input graphical user interface 48 for human command control of the server 20; a Telnet interface 50 for console only (Java independent) control of the server; a channel manager 52 for sorting messages by channel; a channel queue 54 for queuing sorted messages on a first-in first-out basis; a connection handler 56 for handling connections to the clients; a command interpreter 58 for interpreting commands from the clients; a message handler 60 for routing messages; and a discovery beacon 62 for broadcasting the server's availability.

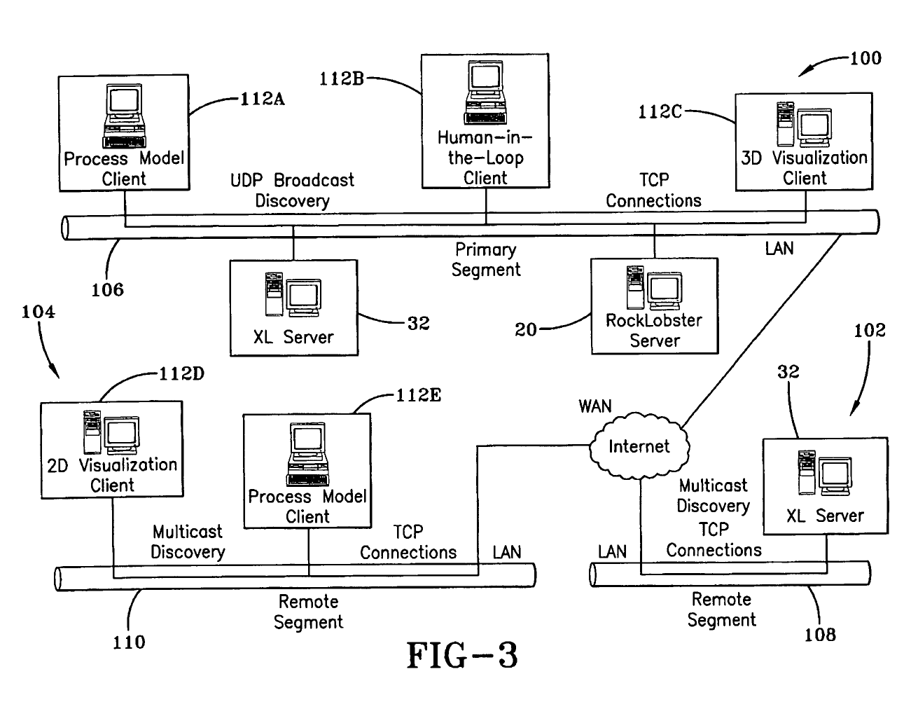

The inherent flexibility of the communications bridge allows for communications to take place across several different platforms (computers and workstations with various operating systems). FIG. 3 is a block diagram of the physical architecture of one embodiment of the invention. FIG. 3 shows how a network of COTS tools may be integrated through the communication server 20 to create a virtual environment to perform analyses of a desired operation. FIG. 3 is a representative sample of a possible arrangement only, the flexibility of the bridge and the protocol of the invention allows for many types of tools to be integrated to allow for a wide range of analyses.

FIG. 3 shows three interconnected local area networks (LANs) 100, 102 and 104. Each LAN comprises an Ethernet segment 106, 108, 110. LAN 100 is “local” and includes the communication server 20. LANS 102, 104 are “remote.” The local and remote LANS 100, 102, 104 may be connected via the Internet to comprise a wide area network (WAN). A plurality of computer workstations 112A-112E store the various models and their communication clients. For example, workstation 112A includes a process model, workstation 112B includes a console emulator (human-in-the-loop), workstation 112C includes a three-dimensional visualization product model, workstation 112D includes a two-dimensional visualization product model and workstation 112E includes another process model. LANs 100 and 102 include EXCEL servers 32.

The communication server 20 is installed on a separate workstation on the network, and a communication client is stored on each workstation that hosts a model. The environment is self-configuring so that any model can start execution at any time and will automatically interface to the communications server 20. The maximum number of servers and clients is not constrained except by the limitations of Ethernet standards. The number of physical ports used is preferably kept to a minimum. One port may be used for discovery and one port may be used for communication to the clients. The ports are not fixed and may be any two ports not in use by other service.

The protocols used on Ethernet segments 106, 108, 110 may include IP as the lowest layer, with TCP and UDP as the next layer. Both broadcast and multicast are used for server discovery. Broadcast is used for anything constrained to the current segment, and multicasts are used for WAN discovery. The existing communication server implementations provide a sustained transaction rate of about 19000 transactions/second using a java server on Linux using a PIII at 1 GHz. Rewriting the communication server in C++ would likely double this transaction rate. Faster processors, multiple processors and Gigabit Ethernet will each increase the speed.

### Operation

When the communication server 20 is started, it starts a process that continuously provides the network with the server 20 location. This may be done using broadcast or multicast, and occurs frequently for as long as the server 20 remains active. Clients listen for this beacon within the startBridge( ) function call. When a client receives a beacon packet, the client checks the content of the beacon packet to identify the simulation the client is supporting. An argument to the startBridge call identifies the simulation that the client is trying to join. If the beacon packet identification matches that of the startBridge call, then the client establishes a TCP connection to the server 20 for all future communication. If the identification in the beacon packet does not match that of the startBridge call, then the client continues to wait for a beacon packet from a communication server 20 serving the client's simulation. Any number of communication servers 20 may be operating at the same time. Each startBridge call makes a connection to only one communication server 20.

Once communications are established by the clients, any number of nbRX (non-blocking receive), RX (receive), and TX (transmit) calls may be used in any order by any client. Because the abstraction of a channel is used, the sender of the message does not have to know anything about the receiver. Messages are queued and are guaranteed to arrive in the sequence that they are sent (FIFO). The sender does not require that the receiver even be connected to the server 20 when the messages are sent. The receiver can connect at a later time and still receive the messages. In fact, the sender does not have to be connected to the server 20 when the messages are received. If synchronization is required, then a message would need to be sent and a reply made. In this way, data exchange can be both synchronous or asynchronous based on the needs of the clients involved. Once a client has completed involvement with the simulation it calls stopBridge and the connection to the server 20 is severed. A client has the option to rejoin the simulation at any time and may do so at any time after calling stopBridge.

### Methodology for Using the Invention

Much work is required prior to running a simulation. The following is a description of the steps involved in using the virtual environment disclosed. These steps describe an efficient means for analyzing existing operations and systems and determining how they might be improved in terms of efficiency, productivity, or other desired outcomes.

Customers identify the operational and system requirements. Models of the current operation (“As Is”) are developed. Subject matter experts work with process modelers to develop and validate process models. Design engineers work with visualization/animation experts to provide three-dimensional images and geometry to describe the environment. Information Management technologists work with information modelers to describe information flow and incorporate real-time database management systems. Each model may include one or more of operational processes, information/communications processes, hardware and systems, physical arrangements and human activities and capabilities.

The models are decomposed to the level required for simulation. A hierarchical decomposition is used to ensure that entities are modeled at the proper level of detail without getting bogged down in excessive detail. A set of metrics is developed for the problem to be addressed. Types of metrics include operational effectiveness, safety, workload, lifecycle operations and support costs, risk assessment, design and build and new technology assessment.

Then, the virtual environment is used to simulate the “As Is” operation to establish and validate a baseline, and develop a set of functional components required to perform the tasks. A set of information models/interfaces are developed to support the data flow between the various elements of the product development. The virtual environment is then used to define a future (“To Be”) operational scenario. The “To Be” operation is optimized by working with customers and subject matter experts to analyze system designs and operations using the virtual environment. Results are simulated by comparing the proposed system to the baseline system utilizing the developed metrics. As a result of this analysis, modifications are made to the model(s) and/or its components. The optimization is continued until maximum benefits are achieved.

The invention offers many advantages and novel features. The invention provides a unified way of analyzing systems operations. This is an advantage over existing methods where analyses are based on the particular tools being utilized. The invention captures a complete picture across all domains. This is an advantage over existing methods where operational environments are modeled from distinct perspectives. The invention is a low cost means for analysis. This is an advantage over existing methods where models are expensive and time consuming to develop, and require manual interpretation to consolidate information from models from different domains. The invention supports design and enhancement of systems and operations. This is an advantage over existing methods where model environments are specific to one aspect of a products lifecycle (e.g. design, development); or to types of entities modeled (e.g. hardware, people).

The invention uses COTS M&S tools rather than developing models using low-level programming. This advantage over existing methods results in reduced cost of model development, increased transportability of models to other environments and reduced model maintenance costs. The invention provides a linkage and synchronization of COTS tools for simultaneous analysis across systems domains. Integration of tools from different modeling domains (e.g. process, product, information) has not been previously achieved. The invention allows COTS tools to have bi-directional control of rate of information flow for increased flexibility and robustness of the virtual environment. This is an advantage over existing call-back methods where each application is controlled as to when to supply and receive information. The invention provides a human-in-the-loop capability for increased realism and training applications. This is an advantage over existing methods where human-in-the-loop is only provided in specific tools, and the human-in-the-loop activities do not impact the overall virtual environment. The invention results in reduced engineering effort to link any COTS models. Currently, integration between a pair of COTS models requires extensive software development and the links are not reusable for other COTS models. The invention allows for models from different domains to be linked across geographical sites using standard networking technology. This is an advantage over existing methods that do not allow linkage of models from different domains, and for methods that do not allow for linkage across different sites.

The invention includes a highly flexible architecture which allows for inclusion of multiple programming languages (c, java, python, etc.), multiple interface technologies (COM, DLL, etc.), and multiple operating systems (UNIX, Windows, etc.). This is an advantage over existing methods that are very limited in the programming languages, interface technologies, and operating systems supported; and rarely allow for integration of tools using different languages, interfaces, and operating systems simultaneously. The invention provides a very fast transaction rate of 20,000 transactions per second with very low latency. This is an advantage over existing methods which limit transactions per second to a much smaller amount.

While the invention has been described with reference to certain preferred embodiments, numerous changes, alterations and modifications to the described embodiments are possible without departing from the spirit and scope of the invention as defined in the appended claims, and equivalents thereof.

What is claimed is:

1. A method of communication between computerized models, comprising:
providing a communication server;
providing a communication client for each of the models, the communication server being connected to each of the communication clients;
sorting information to be exchanged between the models into classes;
assigning a unique identifier for each class of information;
transmitting a message from a communication client to the communication server, the message including a class of information and the unique identifier corresponding to the class of information being transmitted;
sorting messages received at the communication server into groups according to the unique identifier;
queuing the messages within each group temporally;
storing the grouped and queued messages at the communication server;
for each model, identifying which classes of information are needed to operate the model and providing the unique identifiers of the needed classes to the model's communication client; and
using a model's communication client, retrieving a message from the communication server that contains at least one of the unique identifiers provided to the model's communication client.

2. The method of claim 1 further comprising, for a class of information to be received by more than one model, assigning a number of unique identifiers equal to a number of receiving models.

3. The method of claim 2 further comprising assigning two unique identifiers to a class of information that, when transmitted, requires a reply message.

4. The method of claim 1 wherein the step of transmitting the information in a message from the communication client to the communication server includes transmitting the information in a message of a string data type.

5. The method of claim 1 wherein the step of using a model's communication client to retrieve a message from the communication server includes pausing further operation of the model until the message is retrieved.

6. The method of claim 1 wherein the step of using a model's communication client to retrieve a message from the communication server includes continuing operation of the model whether or not the message is retrieved.

7. The method of claim 1 wherein the step of transmitting a message from a communication client to the communication server includes continuing operation of the model after the message is transmitted to the communication server.

8. The method of claim 1 further comprising providing an object server having a communication client connected to the communication server; assigning a unique identifier for each object; and including the unique identifier in messages transmitted from the models' communication clients to the object server.

9. The method of claim 8 further comprising transmitting a message from a model's communication client to the object server, the message including a value of an object and the unique identifier for the object.

10. The method of claim 9 further comprising storing a most recent value of the object at the object server.

11. The method of claim 10 further comprising using a model's communication client to retrieve the most recent value of the object from the object server.

12. The method of claim 1 further comprising creating a log of all messages transmitted to the communication server and storing the transmitted messages.

13. The method of claim 12 further comprising, for each communication client, creating a file of all messages transmitted to the communication server by that communication client.

14. The method of claim 12 further comprising, for each communication client, creating a file of all messages retrieved from the communication server by that communication client.

15. A method of communication between computerized models, comprising:
providing a communication server;
providing communication clients for each of the computerized models, the communication server being selectively connected to one or more of the communication clients;
transmitting a message from a communication client of a model to the communication server, the message including a class of information and a unique identifier corresponding to the class of information being transmitted;
sorting messages received at the communication server into groups according to unique identifiers;
queuing the messages within each group temporally;
storing the grouped and queued messages at the communication server; and
retrieving the transmitted message from the communication server using a second communication client of a second model.

16. The method of claim 15 wherein the step of retrieving the transmitted message from the communication server occurs only when the second model's client sends a receive command.

17. The method of claim 15 further comprising transmitting a number of messages containing a same class of information from a communication client of a model to the communication server, the number of messages including respective unique identifiers corresponding to the class of information being transmitted.

18. The method of claim 17 further comprising retrieving the number of messages from the communication server using a same number of respective communication clients of respective models.

19. The method of claim 15 further comprising transmitting a first message from a first communication client of a first model to the communication server, the message including a first class of information and a first unique identifier corresponding to the first class of information being transmitted; replying to the first message with a reply message from a second communication client of a second model, the reply message including the first class of information and a second unique identifier; and retrieving the reply message containing the second unique identifier using the first communication client of the first model.

20. The method of claim 15 wherein the step of transmitting the information in a message from the communication client to the communication server includes transmitting the information in a message of a string data type.

21. The method of claim 15 wherein the step of retrieving the transmitted message from the communication server using a second communication client of a second model includes pausing further operation of the second model until the message is retrieved.

22. The method of claim 15 wherein the step of retrieving the transmitted message from the communication server using a second communication client of a second model includes continuing operation of the model whether or not the message is retrieved.

23. The method of claim 15 wherein the step of transmitting a message from a communication client to the communication server includes continuing operation of the model after the message is transmitted to the communication server.

24. The method of claim 15 further comprising providing an object server having a communication client connected to the communication server; assigning a unique identifier for each object; and including the unique identifier in messages transmitted from the models' communication clients to the object server.

25. The method of claim 24 further comprising transmitting a message from a first model's communication client to the object server, the message including a value of an object and the unique identifier for the object.

26. The method of claim 25 further comprising storing a most recent value of the object at the object server.

27. The method of claim 26 further comprising using a second model's communication client to retrieve the most recent value of the object from the object server.

28. The method of claim 15 further comprising creating a log of all messages transmitted to the communication server and storing the transmitted messages.

29. The method of claim 28 further comprising, for each communication client, creating a file of all messages transmitted to the communication server by that communication client.

30. The method of claim 28 further comprising, for each communication client, creating a file of all messages retrieved from the communication server by that communication client.

31. A computer readable medium containing a computer program for performing the transmitting, sorting, queuing, storing and retrieving steps of claim 15.

32. An apparatus, comprising:
at least one computer including at least one process model linked to one or more of a product model, information model and computer console emulator model;
respective communication clients for each model;
a communication server selectively connectable to the respective communication clients;
means for transmitting a message from a communication client of a model to the communication server, the message including a class of information and a unique identifier corresponding to the class of information being transmitted;
means for sorting messages received at the communication server into groups according to unique identifiers;
means for queuing the messages within each group temporally;
means for storing the grouped and queued messages at the communication server; and
means for retrieving the transmitted message from the communication server using a second communication client of a second model.

33. The apparatus of claim 32 further comprising means for retrieving the transmitted message from the communication server only when the second model's client sends a receive command.

34. The apparatus of claim 32 further comprising means for transmitting a number of messages containing a same class of information from a communication client of a model to the communication server, the number of messages including respective unique identifiers corresponding to the class of information being transmitted.

35. The apparatus of claim 34 further comprising means for retrieving the number of messages from the communication server using a same number of respective communication clients of respective models.

36. The apparatus of claim 32 further comprising means for transmitting a first message from a first communication client of a first model to the communication server, the message including a first class of information and a first unique identifier corresponding to the first class of information being transmitted; means for replying to the first message with a reply message from a second communication client of a second model, the reply message including the first class of information and a second unique identifier; and means for retrieving the reply message containing the second unique identifier using the first communication client of the first model.

37. The apparatus of claim 32 wherein the means for transmitting the information in a message from the communication client to the communication server includes means for transmitting the information in a message of a string data type.

38. The apparatus of claim 32 wherein the means for retrieving the transmitted message from the communication server using a second communication client of a second model includes means for pausing further operation of the second model until the message is retrieved.

39. The apparatus of claim 32 wherein the means for retrieving the transmitted message from the communication server using a second communication client of a second model includes means for continuing operation of the model whether or not the message is retrieved.

40. The apparatus of claim 32 wherein the means for transmitting a message from a communication client to the communication server includes means for continuing operation of the model after the message is transmitted to the communication server.

41. The apparatus of claim 32 further comprising an object server having a communication client connected to the communication server.

42. The apparatus of claim 41 further comprising means for transmitting a message from a first model's communication client to the object server, the message including a value of an object and a unique identifier for the object.

43. The apparatus of claim 42 further comprising means for storing a most recent value of the object at the object server.

44. The apparatus of claim 43 further comprising means for using a second model's communication client to retrieve the most recent value of the object from the object server.

45. The apparatus of claim 32 further comprising means for creating a log of all messages transmitted to the communication server and storing the transmitted messages.

46. The apparatus of claim 45 further comprising, for each communication client, means for creating a file of all messages transmitted to the communication server by that communication client.

47. The apparatus of claim 46 further comprising, for each communication client, means for creating a file of all messages retrieved from the communication server by that communication client.
